(19) United States
(12) Patent Application Publication
(10) Pub. No.: US 2013/0103417 A1
(43) Pub. Date: Apr. 25, 2013

(54) Medical Care Support System and Method Of Supporting Medical Care

(71) Applicants: Kumiko Seto, Fuchu (JP); Kikuo Umegaki, Sapporo (JP); Masayuki Ohta, Kodaira (JP); Shuntaro Yui, Kokubunji (JP); Satoshi Mitsuyama, Tokyo (JP); Kazuki Matsuzaki, Tokai (JP); Hajime Sasaki, Hachioji (JP); Takuya Kamiyama, Tokyo (JP); Hisaaki Ochi, Kodaira (JP); Yoshihiko Nagamine, Hitachi (JP); Yuji Oka, Tokyo (JP)

(72) Inventors: Kumiko Seto, Fuchu (JP); Kikuo Umegaki, Sapporo (JP); Masayuki Ohta, Kodaira (JP); Shuntaro Yui, Kokubunji (JP); Satoshi Mitsuyama, Tokyo (JP); Kazuki Matsuzaki, Tokai (JP); Hajime Sasaki, Hachioji (JP); Takuya Kamiyama, Tokyo (JP); Hisaaki Ochi, Kodaira (JP); Yoshihiko Nagamine, Hitachi (JP); Yuji Oka, Tokyo (JP)

(73) Assignee: Hitachi, Ltd., Chiyoda-ku, Tokyo (JP)

(21) Appl. No.: 13/807,259

(22) PCT Filed: Jun. 24, 2011
(86) PCT No.: PCT/JP2011/064581

§ 371 Date: Dec. 27, 2012

(30) Foreign Application Priority Data
Jun. 30, 2010 (JP) 2010-148493

(51) Int. Cl. G06Q 50/22

(52) U.S. Cl. CPC G06Q 50/22; G06Q 10/06316
USPC 705/2

(57) ABSTRACT

Provided is a medical care support system for the sharing and reusing of medical information on the basis of a workflow which is a flow of medical-related services. A workflow step that was executed prior to an ongoing workflow step is selected by using a medical information database which has registered a workflow and information of each workflow step in association with medical information; and information is inputted by medical staff in the ongoing workflow step while the medical information registered in the selected workflow step being referred to; and the medical information being referred to and the inputted information are registered in the medical information database in association with the ongoing workflow step.

### TECHNICAL FIELD

The present invention relates to a medical care support system for handling test values and image data of patients and observations of medical staff, and also relates to a technique suitable for supporting decision of the medical staff in medical-related services.

### BACKGROUND ART

In recent years, quality and efficiency of medical care are required to be improved by a factor of increase of medical care expenses and the like. In particular, in an actual medical care field, it is required to construct a system that enables accumulation and reuse of knowledge of medical staff. Patent Literature 1 (Japanese Patent Laid-Open 2002-63280) discloses a technique in which test images of patients to which an observation of a doctor is added are stored in a case database and medical care is supported by searching for a past test image or an observation from the case database.

### CITATION LIST

### Patent Literature

Patent Literature 1: Japanese Unexamined Patent Application Publication No. 2002-63280

### SUMMARY OF INVENTION

### Technical Problem

A medical-related service to a patient is performed in a workflow which is a flow of a series of medical-related services of medical staff. To improve and advance the quality of medical care, it is desired that the knowledge of the medical staff is reused on the basis of the workflow. The system disclosed in Patent Literature 1 described above has a problem that when searching for a past test image or observation and using the past test image or observation in a diagnosis, a part of workflow of medical care which is related to the searched test image or observation is not known and medical-related services performed before and after the part of the workflow are not known, so that a diagnosis using medical knowledge considering the workflow cannot be supported.

### Solution to Problem

To solve the above problem, a medical care support system is provided, which is characterized by including a medical information storing means that stores workflow information that identifies a workflow which is a series of flow of medical care of medical-related services, workflow step information including information that identifies a workflow step, which is a unit of a medical-related service included in the workflow, and information related to at least either one of a request source and a request destination of the medical-related service, and medical information which is information related to the medical-related service into a medical information database in association with each other, a workflow input means that receives an input for selecting first workflow step information from the medical information database, a medical information output means that extracts first medical information associated with the first workflow step information from the medical information database and displays the extracted first medical information on a screen, and an input information receiving means that receives an input of information by a medical staff member, wherein the medical information storing means stores information where an input is received by the input information receiving means and the first medical information into the medical information database as second medical information in association with second workflow step information that identifies a second workflow step which is an ongoing workflow step.

Further, a method of supporting medical care is provided, which supports medical care by using a medical information database for storing workflow information that identifies a workflow which is a series of flow of medical care of medical-related services, workflow step information including information that identifies a workflow step, which is a unit of a medical-related service included in the workflow, and information related to at least either one of a request source and a request destination of the medical-related service, and medical information which is information related to the medical-related service in association with each other, and which is characterized by including a step of receiving an input for selecting first workflow step information from the medical information database by a workflow input means, a step of extracting first medical information associated with the first workflow step information, where the input is received, from the medical information database and displaying the extracted first medical information on a screen, a step of receiving an input of information from a medical staff member by an input information receiving means, and a step of storing the displayed first medical information and the information where the input is received into the medical information database as second medical information in association with second workflow step information that identifies a second workflow step which is an ongoing workflow step.

### Advantageous Effects of Invention

Medical information of a workflow step, which is referred to by a medical staff member when the medical staff member inputs information, is stored along with information inputted in association with an ongoing workflow into a medical information database, which stores a workflow and information of each workflow step in association with medical information, so that it is possible to support accumulating and using an execution process of a medical-related service of each medical staff member and the basis of the execution.

### BRIEF DESCRIPTION OF DRAWINGS

FIG. 1(A) is a diagram showing an example of a configuration when a medical care support system is installed in a hospital.

FIG. 1(B) is a diagram showing an example of another configuration of the medical care support system.

FIG. 1(C) is a diagram showing an example of another configuration of the medical care support system.

FIG. 2 is a diagram showing an example of a structure of a workflow table and a workflow step table included in a medical information database.

FIG. 3(A) is a diagram showing an example of a structure of a medical information table and an evidence data table included in the medical information database.

FIG. 3(B) is a diagram showing an example of a process history table and an input data table included in the medical information database.

FIG. 4 is a diagram showing an example of a structure of a table group included in a test information database.

FIG. 5 is a diagram showing an example of a flowchart for extracting a workflow step from a workflow and supporting medical care by using medical information and a decision text.

FIG. 6 is a diagram showing an example of a flowchart for performing data processing on evidence data and supporting medical care.

FIG. 7(A) is a diagram showing an example of a screen before referring to a test graph and inputting a decision text on the basis of a workflow. FIG. 7(B) is a diagram showing an example of a screen when referring to the test graph. FIG. 7(C) is a diagram showing an example of a screen when inputting a decision text.

FIG. 8A is a diagram showing an example of a screen before referring to image data and inputting a decision text on the basis of a workflow. FIG. 8(B) is a diagram showing an example of a screen when referring to the image data. FIG. 8(C) is a diagram showing an example of a screen when referring to the image data and inputting the decision text on the basis of the workflow.

FIG. 9 is a diagram showing an example of a flowchart for selecting a past workflow and referring to medical information.

FIG. 10 is a diagram showing an example of a flowchart for performing data processing on evidence data and referring to a history of data processing.

FIG. 11A is a diagram showing an example of a screen before selecting a workflow step, referring to image data, and inputting a decision text. FIG. 11(B) is a diagram showing an example of a screen when referring to medical information related to the selected workflow step.

FIG. 11(C) is a diagram showing an example of performing data processing of the image data being referred to. FIG. 11(D) is a diagram showing an example of a screen when inputting a decision text.

FIG. 12 is a diagram showing an example of a flowchart when performing a conference service.

FIG. 13 is a diagram showing an example of a screen for setting and displaying a destination to the next workflow step and a communication statement.

FIG. 14 is a diagram showing an example of a screen when displaying different workflows on the screen and referring to medical information associated with each workflow step.

FIG. 15(A) is a diagram showing an example of a screen before selecting a workflow step when conference is held, referring to image data, and inputting a decision text. FIG. 15(B) is a diagram showing an example of a screen when referring to medical information related to the workflow step selected when the conference is held.

FIG. 15(C) is a diagram showing an example of editing data processing of the image data being referred to when the conference is held. FIG. 15(D) is a diagram showing an example of a screen when inputting a decision text when the conference is held.

### DESCRIPTION OF EMBODIMENTS

### Explanation of Definition of Workflow

A workflow is a flow of a series of medical-related services performed on a patient by medical staff and workflow information is information related to identifying a workflow. A workflow step is a unit of a medical-related service included in a workflow and workflow step information includes information related to identifying a workflow step and information related to at least either one of a request source and a request destination of a medical-related service.

A request of medical-related service is ordering of a medical-related service to each medical department, for example, a testing department or an image diagnosis department. The medical staff include not only attending doctors, laboratory technicians, radiological technicians, and radiologists, but also nurses, medical accounts related personnel, and the like. The start and end of the workflow is determined by, for example, the primary doctor of clinicians. Examples of the workflow include a flow of a series of medical care such as diagnosis of each disease, medical treatment, and follow-up, a flow of medical treatments during hospitalization (from the date of hospital admission to the date of hospital discharge), and a flow determined by a medical care guide line.

Examples of the workflow step include each service (diagnosis, treatment, and follow-up) in a medical care stage of a patient, a diagnosis service performed by a primary doctor, an operation such as medication by a nurse, and an order service unit transferred between medical departments such as a medical care department and a radiological department. The workflow step information can be edited, such as being newly generated or deleted, by medical staff or the like in each workflow step. The workflow step information may be based on a predetermined medical care guide line. The workflow step information includes a patient identifier that identifies a patient related to a corresponding workflow.

### <Explanation of System Configuration>

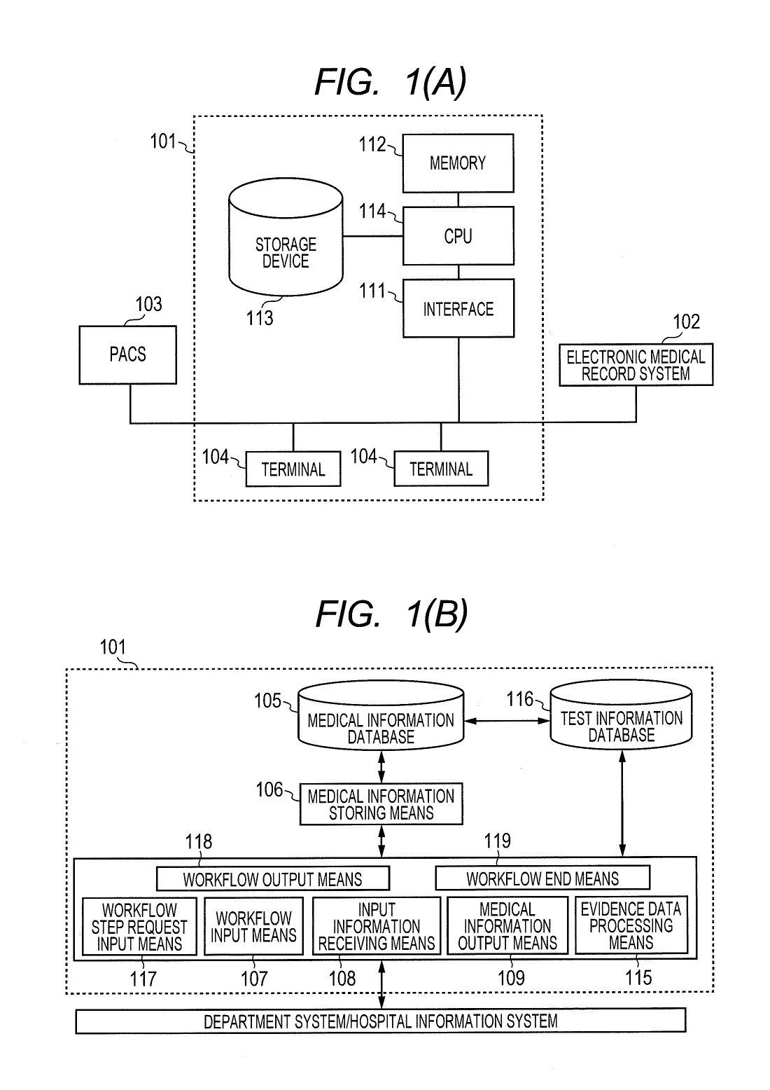

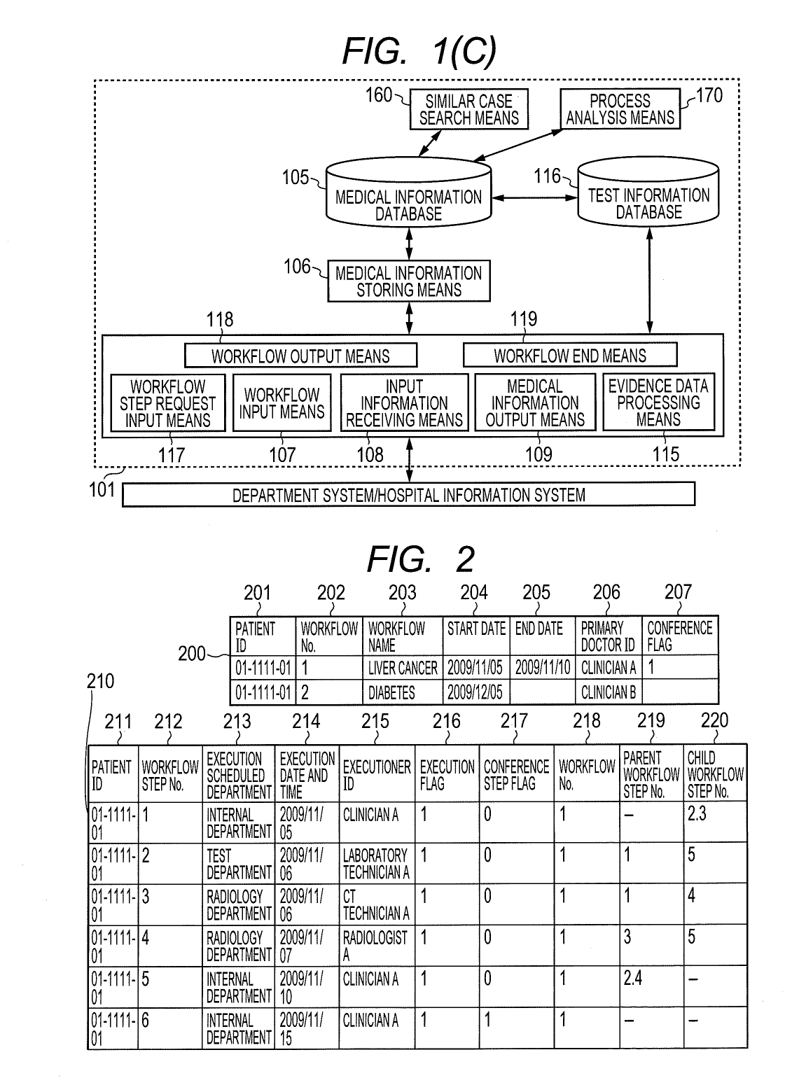

FIG. 1(A) is a diagram showing an example of a configuration of a medical care support system 101 which is installed in a hospital. In the medical care support system 101, terminals 104, an interface 111, a memory 112, a storage device 113 such as a hard disk drive are connected to a CPU 114. An operation of the medical care support system is performed by receiving an input in the terminal 104 by the interface 111, reading a program stored in the memory 112, and outputting the program to the terminal 104 from the interface 111 by using the CPU 114. The medical care support system 101 shown in FIG. 1(A) is installed to be connected to an electronic medical record system 102, a PACS 103, and the like by a network. Each terminal 104 receives an operation input by medical staff such as a doctor, a nurse, a laboratory technician, a radiologist, and the like. Each terminal 104 can use the electronic medical record system 102 and the PACS 103 along with the medical care support system. Diagnosis histories, test values, and image data may be accumulated in the electronic medical record system 102 and the PACS 103. In this case, the storage device 113 of the medical care support system may have information indicating links to these databases or may have copies of data stored in these databases. As shown in FIG. 1(B) described later, a test information database 116, which is a database included in the electronic medical record system 102 and the PACS 103, may be included in the medical care support system. As an example of the interface 111, there is an interface that includes a screen.

FIG. 1(B) shows an example of a configuration of the medical care support system of the present invention. There is a medical information database 105 in which the workflow information, the workflow step information, and the medical information which is information related to medical-related services are stored in association with each other, and a medical information storing means 106 which stores these information is connected to the medical information database 105. The medical information includes information inputted by medical staff and various evidence data. Here, as an example of the information inputted by medical staff, a decision text is used which is a text indicating a decision made in a medical-related service. The evidence data here indicates data that is the base of the decision made by the medical staff. For example, the evidence data includes objective biological information such as test values and image data acquired from a modality, document data such as medical literature referred to by the medical staff when making the decision, and data calculated from the above data by a computer. The medical care support system 101 further includes a workflow input means 107 that receives an input for selecting workflow step information from the medical information database 105, a workflow step request input means 117 that receives an input of information related to a request of a workflow step, an input information receiving means 108 that receives an input of a decision text, a medical information output means 109 that extracts medical information from the medical information database 105 on the basis of the workflow step information and outputs the medical information, a workflow output means 118 that acquires workflow information from the medical information database 105 on the basis of a patient identifier that identifies a patient and outputs the workflow information to the interface 111, and a workflow end means 119 that stores workflow end information into the medical information database 105. The functions of these means are stored in the memory 112 shown in FIG. 1(A).

By this configuration, the medical information is displayed from the medical information database 105 on the basis of the workflow step information selected by the workflow input means 107, and the information inputted by the input information receiving means 108 and the displayed medical information are associated with the ongoing workflow step information and stored in the medical information database 105. In the ongoing workflow step, medical information referred to is stored along with the inputted information, so that information that is referred to and used as the base when performing the workflow step is accumulated, and thus the process of the medical-related services of the medical staff is known.

The medical information database 105 accumulates and manages the medical information that is information related to the medical-related services in each workflow step through the medical information storing means 106. In the medical information database 105, the decision text associated with each workflow step and inputted by the input information receiving means 108, the evidence data processed by an evidence data processing means 115, the processing history of the evidence data, the medical information referred to in each workflow step, and the like are accumulated. As shown in FIG. 1(A) described above, the medical information database 105 may include link information to the medical information accumulated in the electronic medical record system 102 and the PACS 103.

The medical information storing means 106 is a means that stores the workflow information, the workflow step information, and the medical information into the medical information database 105. Examples of the medical information to be stored include the evidence data processed by the evidence data processing means 115, the data processing history including the original evidence data, the information inputted by the medical staff using the input information receiving means 108, and the like.

The test information database 116 accumulates and manages information of test results of medical-related tests such as a blood test and an image test in each workflow step. The database may be realized by sharing databases included in the electronic medical record system 102, a hospital information system such as an ordering system, and an image management system such as the PACS 103, or may be realized by providing a data import means not shown in the drawings and importing data from these systems. Or, a data input means not shown in the drawings may be provided and a doctor, a nurse, or a technician may directly input data. Further, a test result of a patient based on a test method newly developed by a doctor for the purpose of research may be inputted from a data input means not shown in the drawings and accumulated and managed along with normal test results. Further, when the electronic medical record system 102 and the PACS 103 are installed separately from the medical care support system 101, the test information database 116 may include only link information to test information stored in the electronic medical record system 102 and the PACS 103. When a data processing workstation is installed, a history of data processing performed in the data processing workstation may be stored in the test information database 116.

The evidence data processing means 115 is a means that performs data processing using data accumulated in the test information database 116. The evidence data processing means 115 includes a plurality of processing modules. The evidence data processing means 115 for a doctor specialized in image diagnosis (hereinafter referred to as a radiologist) includes, for example, a basic module that performs input/output processes of image data and various filter processes and a function module that has a high-level image processing algorithm and performs a region extraction process and an image position adjustment process. An operator performs a series of processes required for medical care on data by freely combining the above processing modules according to a purpose of the processing and characteristics of the data.

Although here the medical information database 105 and the test information database 116 are logically separated from each other, these databases may be physically one database. For example, the medical information database 105 and the test information database 116 may be integrated into one database. As shown in FIG. 1(A), the electronic medical record system 102 and the PACS 103 may be separately used and link information to these may be included.

As shown in FIG. 1(C), the system can further includes a similar case search means 160 and a process analysis means 170. The similar case search means 160 is a means that searches for a case similar to a case of a certain specified patient by using data of patients accumulated in the medical information database 105 in order to support decision of medical staff. Further, the similar case search means 160 outputs searched medical information and workflow information to which workflow step information associated with the searched medical information belongs.

It is possible to not only refer to medical information related to the similar case, but also refer to workflow information associated with the medical information referred to by the similar case search means 160, so that it is possible to support to actively use the medical information related to the similar case by considering information of workflow steps before and after the workflow step associated with the medical information referred to and the prognosis of the patient in the workflow.

The process analysis means 170 is a means for analyzing a process of medical care on the basis of data of a plurality of patients accumulated in the medical information database 105 in order to improve quality and efficiency of the medical care and extracting information necessary to improve and optimize the process.

### <Explanation of Table Structure of Database>

FIG. 2 shows a workflow information table 200 and a workflow step information table 210 included in a configuration of the medical information database 105.

The workflow information table 200 is a table that stores the workflow information which is information identifying a workflow. Basically, a primary doctor registers the workflow information table 200. The workflow information table 200 includes a patient ID field 201, a workflow No. field 202, a workflow name field 203, a workflow start date field 204, a workflow end date field 205, a primary doctor ID field 206, and a conference flag field 207. The patient ID field 201 stores a patient identifier that is an identifier for identifying a patient. The workflow No. field 202 stores a number and the like that are key information for uniquely specifying each workflow information. The workflow name field 203 stores a workflow name represented by a name of a disease or a name of medical treatment. The workflow start date field 204 stores a start data of the workflow. The workflow end date field 205 stores an end data of the workflow, which is registered when the workflow ends. The primary doctor ID field 206 stores identification information of a primary doctor who is the responsible person of the workflow. Although here a text is stored in the workflow name field 203, ID of a standard master of the name of a disease or the name of medical treatment may be stored. The conference flag field 207 stores an execution flag indicating that a conference has been executed in the workflow.

The workflow step information table 210 is a table that stores the workflow step information which is information identifying each step of a workflow. One step corresponds to one record in the workflow step information table 210. The workflow step information table 210 includes a patient ID field 211, a workflow step No. field 212, a workflow step execution scheduled department ID field 213, a workflow step execution date and time field 214, a workflow step executioner ID field 215, a workflow step execution flag field 216, a conference step flag field 217, a workflow No. field 218, a parent workflow step No. field 219, and a child workflow step No. field 220. The workflow step No. field 212 stores a number and the like that are key information for uniquely specifying each workflow step. The workflow step execution scheduled department ID field 213 stores identification information for uniquely identifying a department scheduled to execute the workflow step, such as a medical care department or a testing department. The workflow step execution date and time field 214 stores a date and time when the workflow step is executed. The workflow step executioner ID field 215 stores identification information for uniquely identifying a medical staff member who actually executes the workflow step. The workflow step execution flag field 216 stores a flag indicating whether the workflow step is executed or not. The conference step flag field 217 stores a flag indicating that the workflow step is a workflow step in which a conference has been executed. The workflow No. field 218 stores identification information for uniquely identifying a workflow to which the workflow step belongs. The parent workflow step No. is identification information for identifying a workflow step which is located before the corresponding workflow step and further which is connected to the corresponding workflow step. The child workflow step No. is identification information for identifying a workflow step which is located after the corresponding workflow step and further which is connected to the corresponding workflow step. The parent workflow step No. and the child workflow step No. have a role to connect a request source and a request destination of an order.

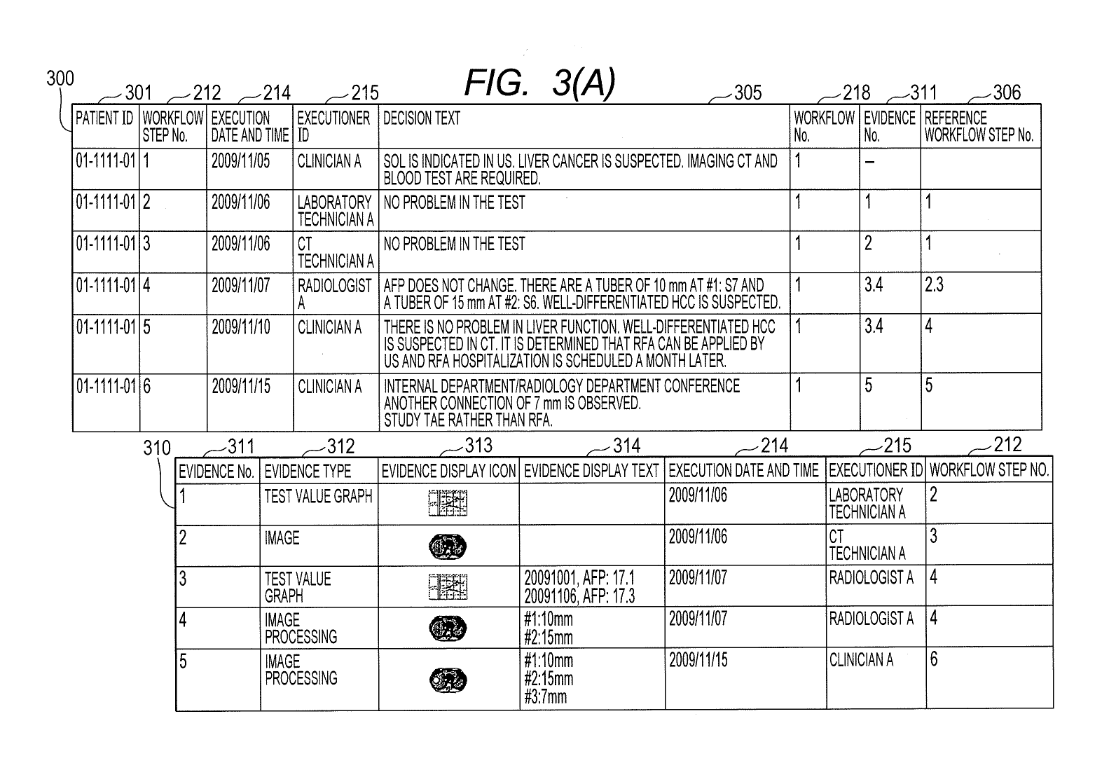

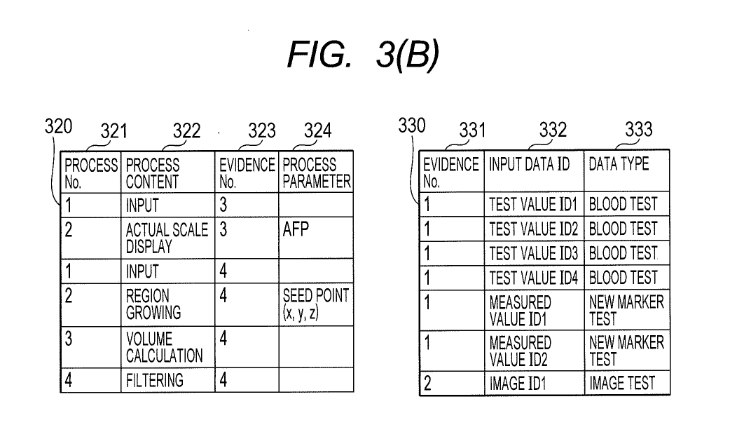

FIG. 3(A) shows a medical information table 300 and an evidence data table 310 included in a configuration of the medical information database 105. FIG. 3(B) shows a process history table 320 and an input data table 330 that are also stored in the medical information database 105.

The medical information table 300 is a table that stores medical information, which is information related to the medical-related services, on the basis of the workflow step and one piece of medical information is stored in one record. This table includes a patient ID field 301, a workflow step No. field 212, a workflow step execution date and time field 214, a workflow step executioner ID field 215, a decision text field 305, a workflow No. field 218, an evidence No. field 311, and a reference workflow step No. field 306. The patient ID field 301 stores a patient identifier that identifies a patient. The decision text field 305 stores a decision text inputted in the corresponding workflow step. When a decision text is included in the medical information referred to when the decision text is inputted into the decision text field 305, the referred decision text can be also stored in the decision text field 305. The inputted decision text and the referred decision text can be differentiated on the basis of the reference workflow step No. The workflow step No. field 212 stores link information to the workflow step No. field 212 in the workflow step information table 210 when the medical information is registered. Thereby, the workflow step information table 210 and the medical information table 300 are associated with each other. The evidence No. field 311 is an identifier that specifies evidence data, which is the basis on which the decision is made, and is associated with the evidence data table 310. In this way, in the medical information table 300, the decision text and the evidence data which is the basis of the decision are stored based on the workflow step information. The reference workflow step No. field 306 stores a workflow step No. referred to in the workflow step No. of the record.

The evidence data table 310 is a table that stores evidence data. One evidence data is stored in one record. The evidence data table 310 includes an evidence No. field 311, an evidence type field 312, an evidence display icon field 313, an evidence display text field 314, a workflow step execution date and time field 214, a workflow step executioner ID field 215, and a workflow step No. field 212. The evidence No. field 311 stores a number and the like that are key information for uniquely specifying each evidence data.

The evidence data processing means 115 performs different processing depending on the type of inputted test information such as, performing image processing on an image and performing graph processing or statistical processing on test values. Here, for example, evidence data for different types of processing such as image processing and graphing of the test values are stored as different records respectively. Here, the evidence type field 312 stores a type of a medical care support process from which the evidence data is extracted. The evidence display icon field 313 and the evidence display text field 314 store information from which content of the evidence data can be recognized. Although an icon image may be directly stored in the evidence display icon field 313 as shown in FIG. 3(A), identification information of the icon image such as a file name may be stored. The workflow step No. field 212 stores link information to the workflow step No. field 212 in the medical information table 300. By this link, various data of the evidence data stored in the evidence data table 310 are associated with the medical information table 300 through the links of the workflow step No. Although the above shows an example of storing patient data as the evidence data, when, for example, document data such as medical paper is referred to, a type of a medical care support process different from an image or test values may be set in the evidence type field 312 (for example “document search” is set) and text in the document data or link information to the document data may be stored in the evidence display text field 314 or another field.

As shown in FIG. 3(B), the process history table 320 is a table that stores a history of processes performed on the test information that is information of the evidence data before being processed. One process history is stored in one record. The process history includes a process history of test values and a process history of image data and these process histories are also included in the medical information. The process history table 320 includes a process No. field 321, a process content field 322, an evidence No. field 323, and a process parameter field 324. The process No. field 321 stores a number and the like that are key information for uniquely identifying each process included in the process history. The process content field 322 stores necessary minimum information for a computer to reproduce, analyze, and reuse the process later, that is, information that can identify process content. FIG. 3(B) shows information related to a process history of image processing and test value processing. In the test value processing (the evidence No.=3), a case in which a test result is read and a plurality of test items are graphed in an actual scale is shown and “input” and “actual scale display” are registered. In the image processing (the evidence No.=4), a case in which a test image is read, a region extraction process (here, for example, region growing method) is performed on a tumor region, and the volume of the tumor region is calculated is shown and “input”, “region growing”, and “volume calculation” are registered in order of process. The evidence No. field 323 stores a value of the evidence No. field 311 in the evidence data table 310. It is indicated that processes are performed on the evidence data identified by the same evidence No. in order of number in the process No. field 321. The process parameter field 324 is a parameter set when each process is performed. Although, in this example, parameters are set in one field for convenience of description, it depends on a process. Therefore, a different process parameter table may be provided for each type of process. Although, in this example, each process included in the evidence data is individually stored in a table in a database, it is possible to provide a process history binary field in the evidence data table 310 and store the process history and input/output data of each process in an independent binary format. Thereby, when reproducing the process, the process can be quickly reproduced and easily implemented by directly transferring binary data to the evidence data processing means 115 without referring to the process history table 320 and the input data table 330. In this way, the process content and the like in the process history table 320 are associated with records stored in the evidence data table 310 and the medical information table 300 through the evidence No.

The input data table 330 stores input data used in the first process in the process history in the evidence data by linking to the test information database 116. One input data is stored in one record. The input data table 330 includes an evidence No. field 331, an input data ID field 332, and an input data type field 333. The input data ID field 332 stores a number and the like that are key information for uniquely specifying the test information in the test information database 116 as input data to each evidence data. The input data type field 333 stores a data type for defining a link destination of an ID stored in the input data ID field 332. For example, when the data type is “blood test”, the input data ID is a test value ID for uniquely identifying the test value of the patient, when the data type is “image test”, the input data ID is an image ID for uniquely identifying the image of the patient, and when the data type is “new marker test”, the input data ID is a measured value ID for uniquely identifying the measured value of the patient of the new marker test. In this way, the input data table 330 is associated with records stored in the evidence data table 310 and the medical information table 300 through the evidence No. field 331.

### <Test Information Database>

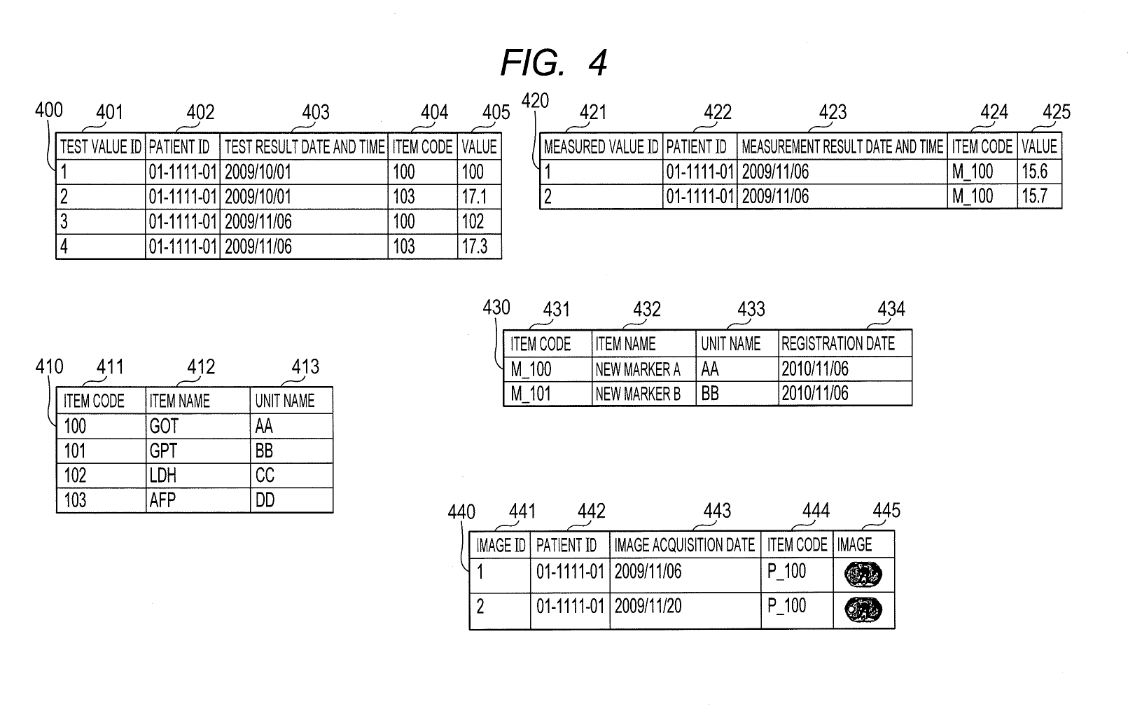

FIG. 4 shows an example a table group included in the test information database 116. The test information database 116 stores detailed information of the evidence data related to medical care and includes a test value table 400, a test item master table 410, a measured value table 420, a measurement item master table 430, and an image table 440. Here, the details of each table will be described. The test value table 400 is a table that stores content of “blood test” data. One test value is stored in one record. The test value table 400 includes a test value ID field 401, a patient ID field 402, a test result date and time field 403, an item code field 404, and a value field 405. The test value table 400 is associated with the test item master table 410 by the item code as a key. The test item master table 410 is an item master table of the “blood test” and includes an item code field 411, an item name field 412, and a unit name field 413. The measured value table 420 is a table that stores content of “new marker test” data. One measured value is stored in one record. The measured value table 420 and the measurement item master table 430 are configured in the same structure as that of the test value table 400 and the test item master table 410. The measured value table includes a measured value ID field 421, a patient ID field 422, a measurement result date and time field 423, an item code field 424, and a value field 425. The measurement item master table 430 includes an item code field 431, an item name field 432, and a unit name field 433. In the measurement item master table 430, it is possible to provide a field for storing registration information of the measurement item (for example, a registration date field 434 and the like) in addition to the fields included in the test item master table 410 and perform version management of the item.

As described above, here, in the test information database 116, the “blood test” and the “new marker test” in the content of the input data are separately managed, and in the input data table 330, only the link information is collectively managed. Thereby, test values measured in a normal operation and test values measured by a test method newly developed for purpose of research can be accumulated as the evidence data in the same manner, so that the effectiveness of the newly developed test method can be analyzed.

The image table 440 includes an image ID field 441 that stores an identifier for identifying an image, a patient ID field 442 that stores a patient identifier, an image acquisition date field 443 that stores date and time when the image is acquired, an item code field 444 that stores an item code, and an image field 445 that stores an image.

### <Example of Radiologist>

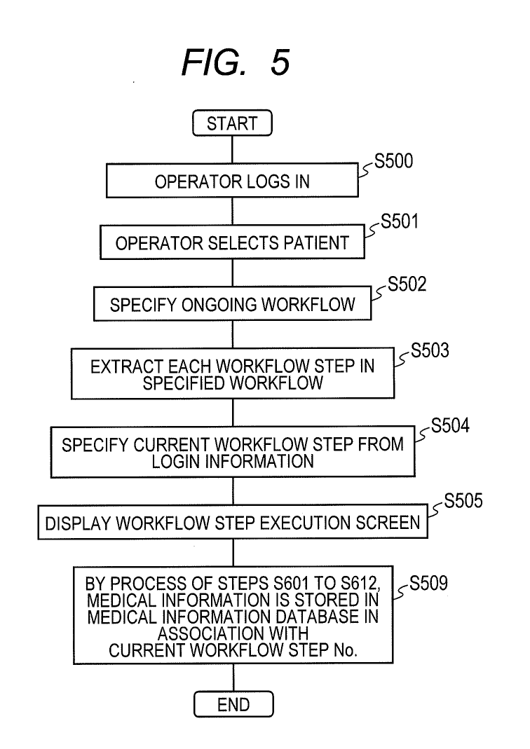

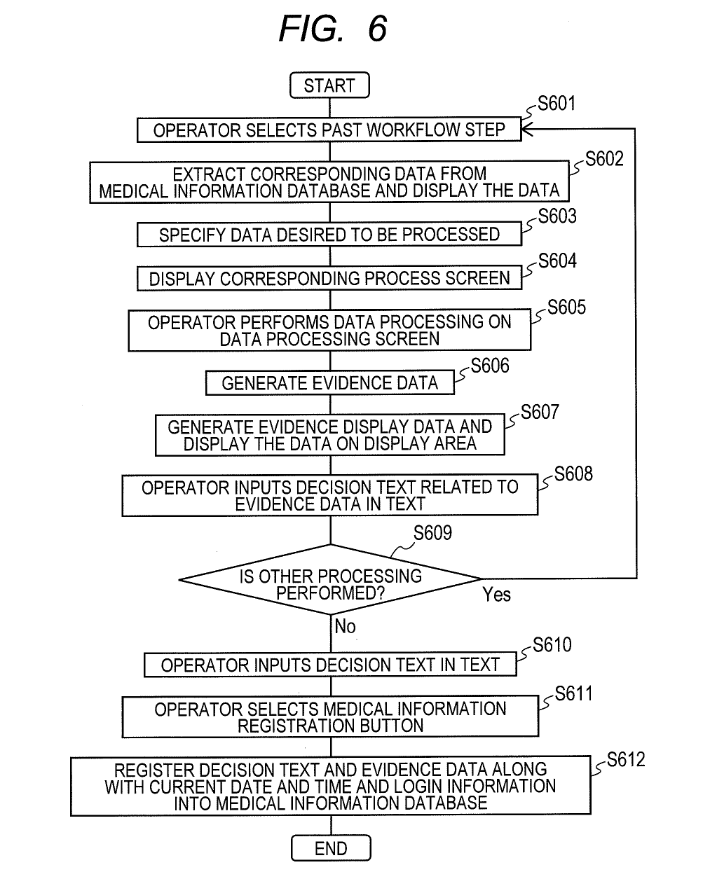

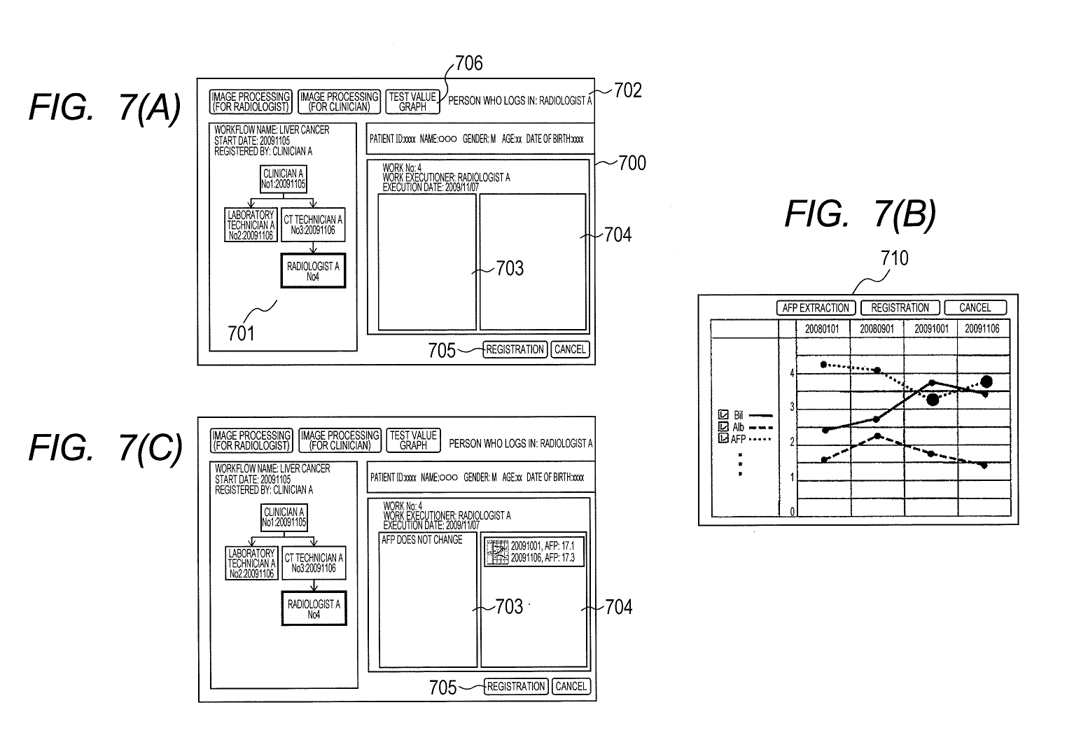

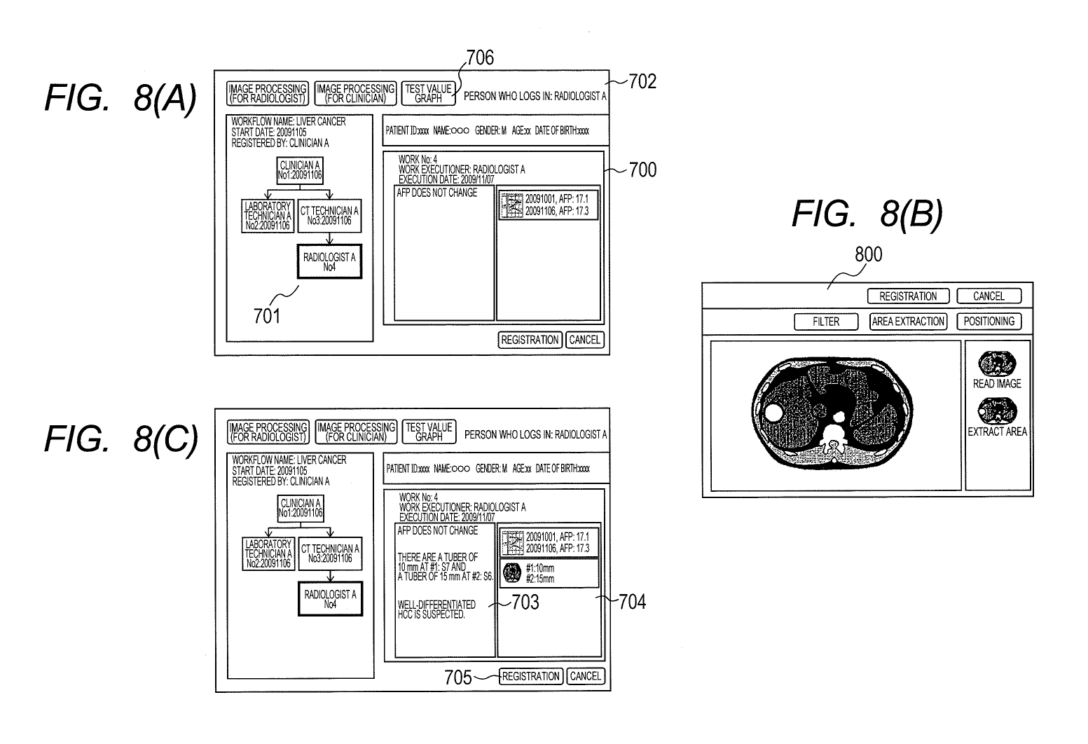

Next, an operation of the system will be described in detail with reference to process flows in FIGS. 5 and 6 and screen examples in FIGS. 7 and 8.

In the system, first, the terminal 104 receives a login input from a login screen operated by an operator (step S500). Next, when the terminal 104 receives an input for selecting a patient identifier of one patient from a patient selection screen operated by the operator (step S501), the medical information storing means 106 identifies a currently ongoing workflow No. of a record corresponding to the patient acquired in step S501 from the workflow information table 200 in FIG. 2 (step S502). Here, as a method for identifying the currently ongoing workflow No., for example, a record in which a value in the workflow end date field 205 is not registered may be identified, or all records corresponding to the patient acquired in step S501 are extracted from the workflow information table 200, a workflow selection screen is displayed, and the operator may specify one workflow.

The medical information storing means 106 acquires corresponding workflow step information from the workflow step information table 210 in FIG. 2 by using the workflow No. identified in step S502 (step S503). A current workflow step No. is identified from department information in the login information acquired in step S500 (step S504). The current workflow step is a currently ongoing workflow step in the workflow. Regarding identification of the current workflow step, for example, the medical information storing means 106 refers to the workflow step execution scheduled department ID field 213 and the workflow step execution flag field 216 in the record acquired in step S502 and extracts a workflow step No., which is a step of a department corresponding to a department of the person who logs in and which is not executed, as the current workflow step No. to recognize the current workflow step. When all steps have been executed, the last step No. is recognized as the current workflow step No. Next, the workflow output means 118 sets each workflow step information acquired in step S503 on a workflow step execution screen 700 shown in FIG. 7 and displays the workflow step information (step S505). The workflow step execution screen 700 is displayed on the interface 111 shown in FIG. 1.

For example, as shown in FIG. 7, the workflow step execution screen 700 of FIG. 7 includes a login information display area 702, a workflow step selection area 701, a decision text input/output area 703, an evidence data display area 704, a medical information registration button 705, and a medical care support button group 706. The workflow step selection area 701 displays workflow steps from the start step of the workflow to the current step in a flowchart format on the basis of information in the parent workflow step No. field 219 in the workflow step information table 210. For example, as shown in the workflow step information table 210 in FIG. 2, the workflow steps whose workflow step No. is 2 and 3 have a parent workflow step No. of 1, so that the workflow steps are connected to a workflow step whose workflow step No. is 1, and further, the workflow step whose workflow step No. is 4 has a parent workflow step No. of 3, so that the workflow step is connected to a workflow step whose workflow step No. is 3. The workflow steps are also connected using the child workflow step No. in the same manner. In this way, the workflow information and the workflow step information are displayed in the workflow step selection area 701 in FIG. 7 so that the request source and the request destinations are connected.

The login information display area 702 is an area in which information of an operator who currently logs in the system is displayed. The decision text input/output area 703 is a display area where content which is decided by a medical staff member and inputted/outputted in a text format is displayed. The evidence data display area 704 displays evidence data. The medical information registration button 705 is a button for registering the evidence data and the text in combination with each other into the medical information database 105 when the operator clicks the button. The medical care support button group 706 is buttons for a medical staff member to call functions of the evidence data processing means 115 which performs data processing such as image processing and test value processing to perform medical care on a patient. Selectable or not selectable of the medical care support button group 706 may be set from a job title in the login information acquired in step S500.

Here, in the workflow step selection area 701, for example, the current workflow step recognized in step S504 is highlighted. In each workflow step, information indicating a progress status of the workflow is displayed. In FIG. 7, for example, a display format is used in which completed or not completed is shown, such as display color is changed according to the content of the workflow step execution flag field 216. For a completed workflow step, the content of the workflow step execution date and time field 214 and the content of the workflow step executioner ID field 215 are displayed.

Here, a radiologist A starts an image reading operation and registers the medical information. The radiologist A performs the image reading operation by the process of steps S601 to S612 in FIG. 6 (described later). When the image reading operation is completed, the medical information storing means 106 registers the medical information displayed in association with the current workflow step No. identified in step S504 into the medical information database 105 (step S509).

FIG. 6 shows a detailed operation of the system when the medical information is registered. Here, an example is shown in which, in a workflow step of the image reading operation, the image reading is performed by referring to the medical information in a workflow step of a laboratory technician A and a CT technician A and the referred medical information and the image reading result are stored in association with the ongoing workflow step by the system.

First, the operator performs an input for selecting the workflow step information of the laboratory technician A (step S601). The workflow input means 107 receives an input for selecting the workflow step information from the medical information database 105. The medical information output means 109 searches for the medical information associated with the selected workflow step (workflow step No. 2) of the laboratory technician A from the medical information database 105 and displays the medical information on the workflow step execution screen 700 (step S602). Here, it is assumed that a test value graph of evidence No. 1 acquired by the laboratory technician A is registered in the medical information. The radiologist A specifies that the displayed test value graph is data desired to be data-processed (step S603). A test value graph display screen 710 as shown in FIG. 7(B) is displayed (step S604). In the test value graph display screen 710, selection of test item to be displayed, setting of graph format, input of data processing such as extraction of a point of interest and data variation are received (step S605). Here, data processing called “AFP extraction” for selecting and extracting a value of AFP is performed. The evidence data processing means 115 extracts a value of AFP selected by the operator from data of AFP in the test value graph by the “AFP extraction”. In FIG. 7(B), the selected data of AFP is shown by enlarging dots that indicate data of selected two points. The values of AFP extracted in step S605 and date are acquired as the evidence data along with the displayed test value graph (step S606). The medical information output means 109 generates display data “graph icon file 1” and “20091001, AFP: 17.1, 20091106, AFP: 17.3” of the evidence data from the acquired data and displays the display data in the first line of the evidence data display area 704 (step S607). Next, the operator inputs a decision text “AFP does not change” related to the data processing of the test value graph into the decision text input/output area 703 (step S608). The input information receiving means 108 receives this input.

It is determined whether or not the operator performs other data processing (step S609) and if the operator performs other data processing, the process returns to step S601 and the processes are repeated. In this example, the operator performs image processing on a CT image captured in a workflow step of the CT technician A. The workflow input means 107 receives an input for selecting the workflow step (workflow step No. 3) of the CT technician A. In step S602, image data (evidence No. 2) is acquired and displayed. The displayed image data is specified as data desired to be processed (step S603). In step S604, an image processing screen 800 as shown in FIG. 8(B) is displayed. In step S605, the radiologist A performs region extraction of a tumor on a CT image. The details of the processing on the image processing screen 800 will be described later. In step S606, an image processing history from inputting image on the image processing screen 800, through extracting an area, to calculating the volume of the tumor area and input data “image ID1” are acquired. In step S607, by using information of the image processing history, display data “image icon file 1” and “#1: 10 mm #2: 15 mm” of the evidence data are generated and displayed in the evidence data display area 704. In step S608, the operator inputs a decision text “there are a tuber of 10 mm at #1: S7 and a tuber of 15 mm at #2: S6” related to the image processing into the decision text input/output area 703. The input information receiving means 108 receives this input.

Next, in step S609, if it is determined that the operator does not perform additional processing, a decision text, for example, “well-differentiated HCC is suspected”, which is not inputted for each evidence data, is additionally inputted into the decision text input/output area 703 as needed (step S610). The input information receiving means 108 receives this input. Finally, the operator selects the medical information registration button 705 (step S611). When the medical information registration button 705 is selected, the medical information storing means 106 acquires the current date and time from hardware on which the medical care support system is installed and acquires medical staff member information “radiologist” of the person who logs in from the medical information database 105. The medical information storing means 106 registers the text in the decision text input/output area 703, the history of processes extracted by the evidence data processing means 115 and the input data, and the patient identifier selected in step S501, the date and time, the medical staff member information, the workflow step execution flag “true”, and the workflow step No. into each table of the medical information database 105 described above (step S612). In this example, the evidence No. 3 is registered corresponding to the test value graph on which data processing is performed, and the evidence No. 4 is registered corresponding to the data on which image processing is performed.

In the decision text input/output area 703 in this example, the texts that are inputted/outputted in step S608 and step S610 are handled as one data. However, the decision text input/output area 703 may be divided into decision text input/output areas for each evidence data (decision text area of the test value graph, decision text area of the image processing) and decision text input/output areas related to all evidence data, and in step S612, these decision texts may be registered by differentiating these decision texts by adding tag information that differentiates these decision texts. The decision text for each evidence data may have link information to the evidence data.

In this way, evidence data corresponding to a medical care service in a workflow step performed before the current workflow step is displayed, data processing is performed, an input of a decision text based on the evidence data on which the data processing is performed is received in the current workflow step, and the decision text and the evidence data displayed when the decision text is inputted are registered in association with the current workflow step, so that it is possible to accumulate processes in which the medical care services of the medical staff are performed, that is, manners how each medical staff member views data and makes a decision in each workflow step, in association with the workflow step. Thereby, it is possible to support medical care while actively using implicit knowledge of each medical staff member along the workflow. Further, the process history of the evidence data is stored based on the workflow step, so that correspondence relationship between a decision of a medical staff member in each workflow step and the data processing history can be accumulated.

### <Example of Clinician>

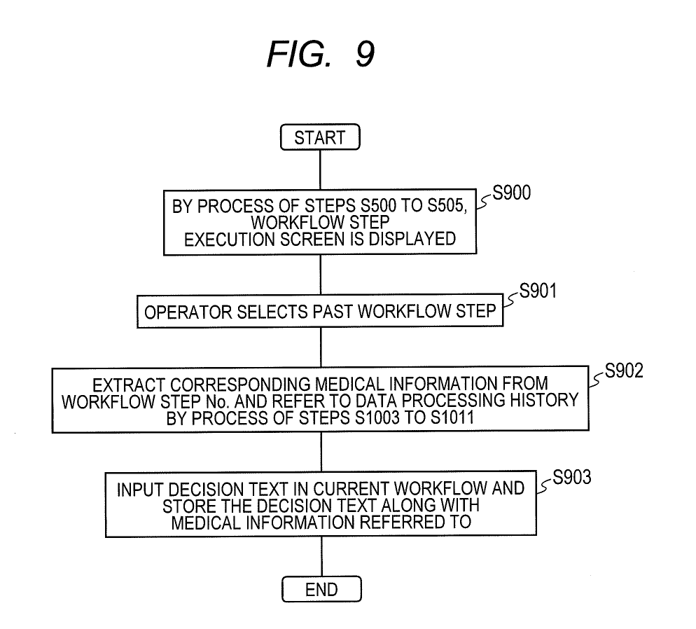

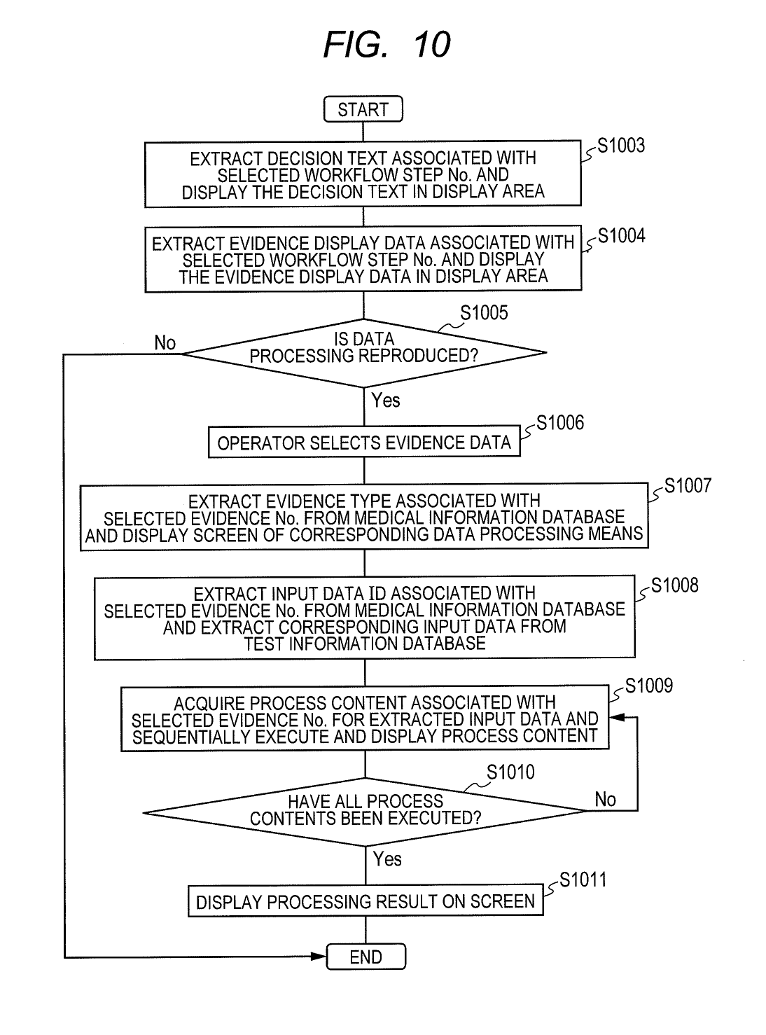

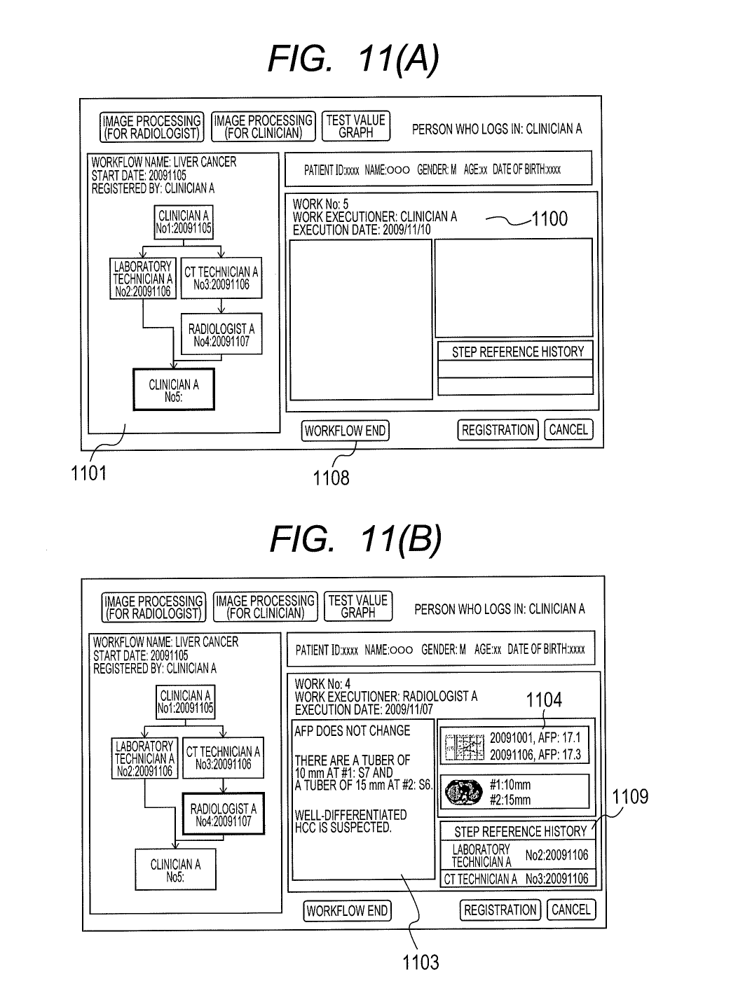

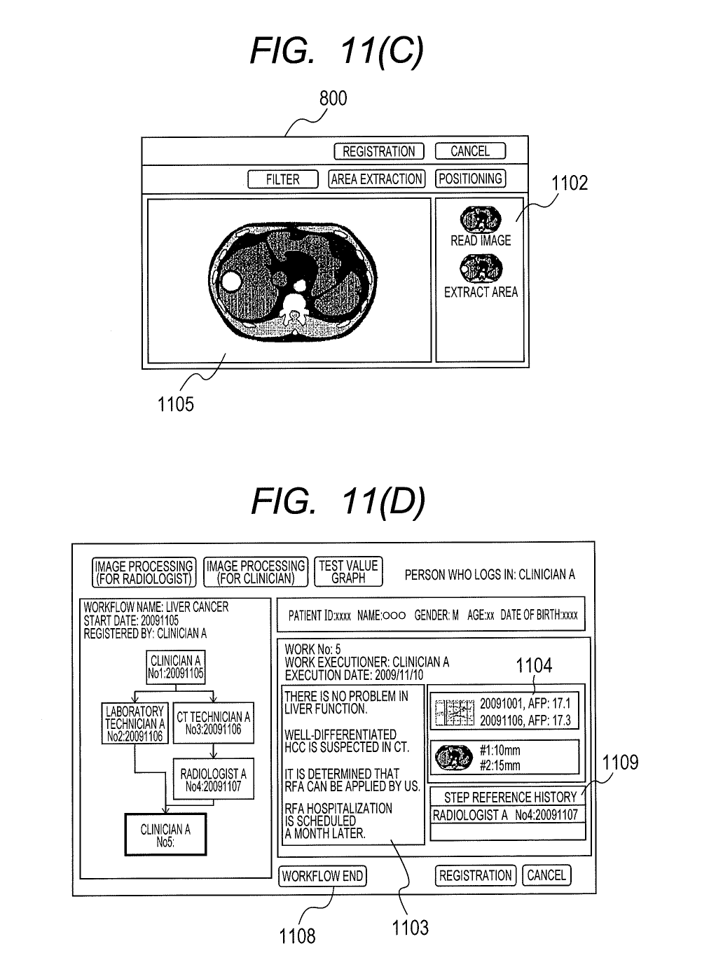

Next, an operation of another example of the system will be described in detail with reference to process flows in FIGS. 9 and 10 and screen example in FIG. 11.

In the system, the operator logs in from the login screen by the same process as that in steps S500 to S505 in FIG. 5 and selects a patient. Thereafter, a workflow step execution interface 1110 in FIG. 11 is displayed (step S900). Here, a clinician A logs in, so that, in FIG. 11(A), the current workflow step of the clinician A is highlighted in a workflow step selection area 1101.

Here, the clinician A performs medical care while referring to a decision made by the radiologist A on the patient to whom medical care is provided. The workflow step (workflow step No. 4) of the radiologist A in the workflow step selection area 1101 is selected by the clinician A (step S901). The workflow input means 107 receives an input for selecting the workflow step.

The medical information output means 109 searches for the medical information table 300, the evidence data table 310, and the process history table 320 in FIG. 3 from the received input for selecting the workflow step and displays a process screen by processes from steps S1003 to S1011 (step S902).

The medical information output means 109 first searches for the medical information table 300 in the medical information database 105 from the workflow step No. corresponding to selected medical information, acquires corresponding one record, and displays the decision text in the corresponding record in the decision text input/output area 1103 (step S1003). Further, the medical information output means 109 searches for a corresponding record in the evidence data table 310 from the acquired workflow step No. and displays a set of the evidence display icon and the evidence display text in the corresponding record in an evidence data display area 1104 in order of the evidence No. (step S1004).

Here, an example is shown in which, by using the system, medical care is performed while referring to not only a result report of the radiologist A but also the process of the medical practice where the report is made, the clinician A makes a decision while reproducing the data processing when the image was read, and the referred medical information including data processing and the decision text of the clinician A are stored on the basis of the ongoing workflow step of the clinician A, so that the medical care is supported.

The evidence displayed here are the evidence No. 3 and the evidence No. 4. The clinician A refers to the evidence data display area 1104 and determines whether or not the clinician A wants to reproduce and refer to not only the content of the evidence display text but also the procedure of the data processing of the radiologist A (step S1005), and when the clinician A wants to refer to the procedure of the data processing, corresponding evidence data in the evidence data display area 1104 is selected (step S1006). When the clinician A does not refer to the procedure of the data processing, in other words, when the evidence data is not selected, the process ends.

The medical information output means 109 searches for the evidence data table 310 in the medical information database 105 from the evidence No. corresponding to the selected evidence, acquires corresponding one record, and starts a process screen according to the content of the evidence type (in this example, image processing screen 1110) (step S1007).

Next, the medical information output means 109 acquires the input data ID from the input data table 330 in the medical information database 105 on the basis of the evidence No. corresponding to the selected evidence and reads the input data corresponding to the input data ID from the test information database 116 (step S1008).

Further, the evidence data processing means 115 searches for the process history table 320 in the medical information database 105 from the same evidence No. acquires corresponding process content, executes the process content on the input data (in this example, image data) acquired in step S1008 in order of the process No., and displays the execution result (step S1009).

The evidence data processing means 115 checks whether or not the last process content has been executed (step S1010), and when the last process content has been executed, the evidence data processing means 115 sets the process result in a process result display area 1105 (step S1011). When the last process content has not yet been executed, the evidence data processing means 115 returns to step S1009 and executes the next process content. Although not shown in the drawings, when there is a parameter that should be inputted by the operator when the process is executed, the evidence data processing means 115 reads the parameter information from the process history table 320 and executes the parameter information. By this configuration, the process is re-executed without leaving a process result image of each process content and the process history is generated, so that the amount of data is not so large. However, when the process content needs to be processed quickly, the process result obtained while the process history is generated may be accumulated in binary format along with the evidence No. without using the process history table 320 and the input data table 330 and the process result may be set in the image processing screen.

FIG. 11(B) shows an example in which the medical information of the radiologist A referred to by the clinician A, that is, the decision text “AFP does not change. There are a tuber of 10 mm at #1: S7 and a tuber of 15 mm at #2: S6. Well-differentiated HCC is suspected.” in the decision text input/output area 1103, and the test graph and a result of tumor quantification in the CT image in the evidence data display area 1104 are displayed as the evidence data. In a step reference history area 1109, it is indicated that the workflow steps referred to by the radiologist A are “laboratory technician A No. 2: 20091106” and “CT technician A No. 3: 20091106”.

FIG. 11(C) is an example in which the evidence data display area 1104 is selected and an image processing screen for a radiologist is displayed, and in this example, a process history until the tumor quantification is performed is displayed. When referring to the process history, even the procedure of data processing can be reproduced by starting the evidence data processing means 115 for other job titles that generate the evidence data in this way.

FIG. 11(D) shows an example in which the clinician A inputs a decision text while referring to the medical information of the workflow step of the radiologist A. In the step reference history area 1109, the history of the workflow steps referred to is displayed, and here, the workflow step of the radiologist A of the workflow step No. 4 is displayed.

The input information receiving means 108 can receive an observation of the clinician A, which is inputted while the clinician A refers to the medical information associated with the workflow step of the radiologist A, for example, an input of “There is no problem in liver function. Well-differentiated HCC is suspected in CT. It is determined that RFA can be applied by US. RFA hospitalization is scheduled a month later.”, as a decision text. After receiving the input of the decision text, the medical information registration button 705 is pressed, and the workflow step No. and the medical information of the radiologist A, which are referred to by the clinician A, and the decision text of the clinician A are registered in the medical information database 105 on the basis of the current workflow step. Here, the current workflow step is a workflow step of No. 5, and various data are stored in a corresponding record. The decision text displayed in the decision text input/output area 1103 is stored in the decision text field 305 and the evidence data displayed in the evidence data display area 1104 is stored in the evidence data table 310 and the process history table 320. Each workflow step No. referred to by the radiologist A, which is displayed in the step reference history area 1109, is stored in the reference workflow step No field 306. (step S903).

Further, when a workflow end button 1108 is pressed, the workflow steps up until the current workflow step can be ended as one workflow. The end date and time is recorded in the workflow end date field 205 in the workflow information table 200. The end date and time is an example of workflow end information indicating that the corresponding workflow ends. The workflow end button 1108 is an example of the workflow end means 119 and can end the workflow to support management of the workflow.

In this way, medical information corresponding to a medical practice in a workflow step performed before the current workflow step is displayed, an input of a decision text based on the evidence data is received in the current workflow step, and the decision text and the medical information displayed when the decision text is inputted are registered in association with the current workflow step, so that it is possible to accumulate thinking processes of the medical staff, that is, manners how each medical staff member refers to various medical information and makes a decision in each workflow step, in association with the workflow step. Thereby, it is possible to support medical care while actively using implicit knowledge of each medical staff member along the workflow. Further, the medical information referred to includes a history of data processing when evidence data is generated and the processing history can be easily reproduced, so that medical staff can share decisions of other medical staff including the process in which other medical staff generate the evidence data. As a result, it is possible to support improving the quality and efficiency of the medical care.

<Operation when Conference is Held>

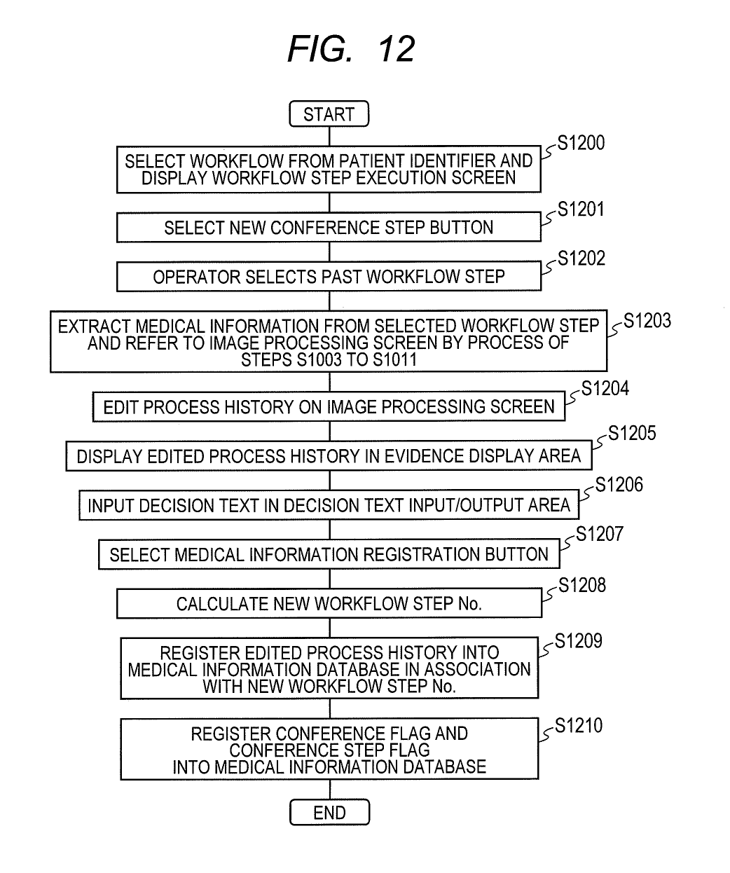

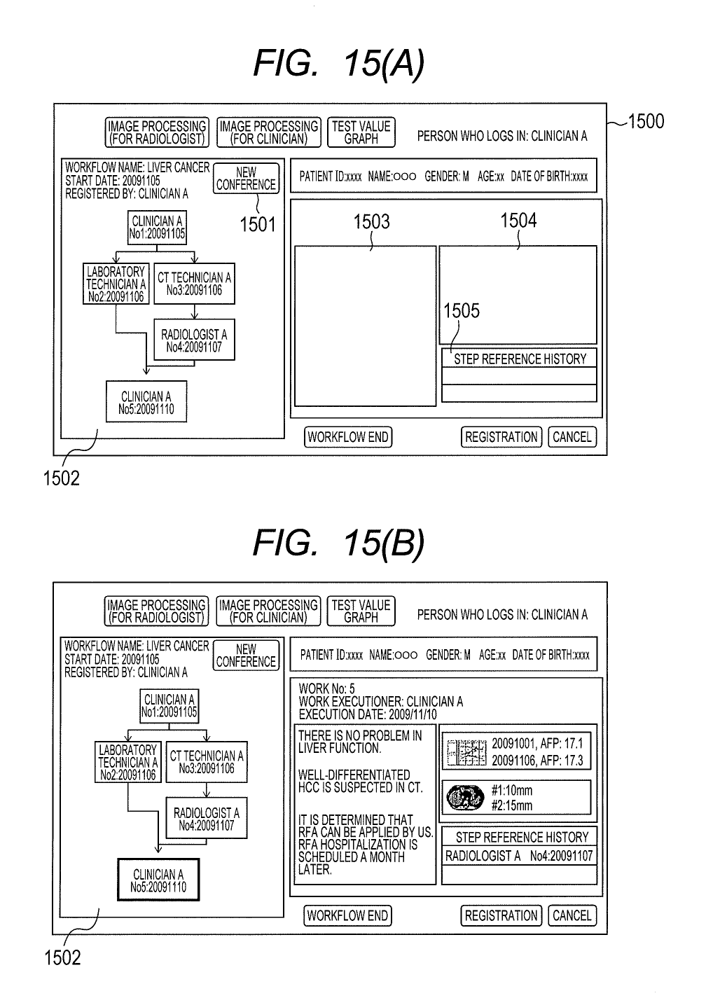

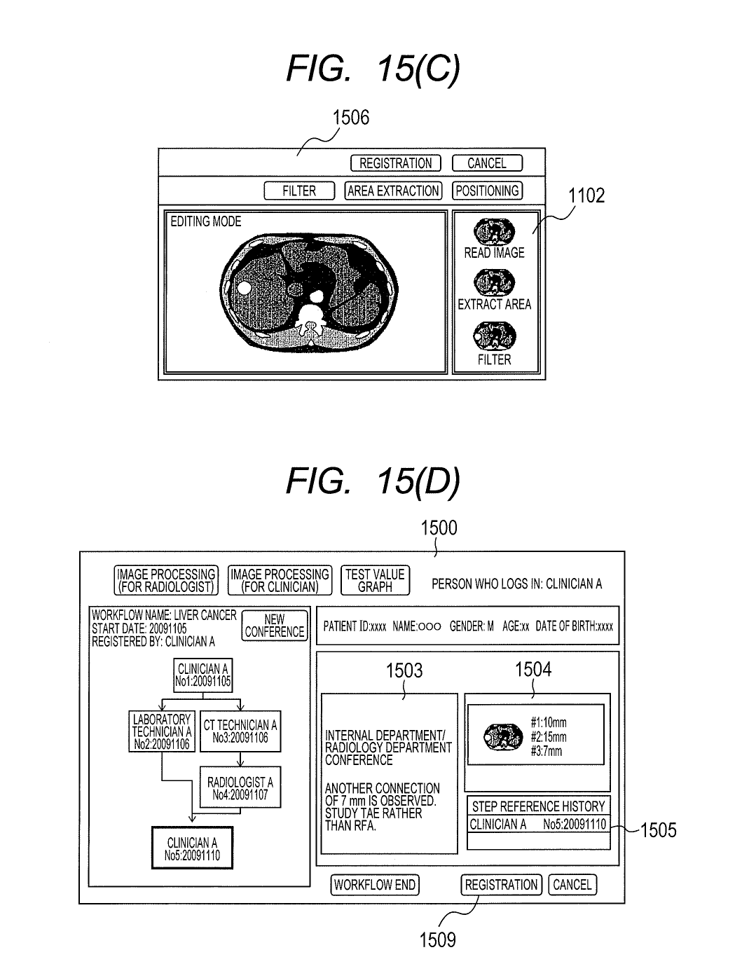

Next, an example of reusing a past process history in a workflow step when a conference is held will be described with reference to FIGS. 12 and 15.

First, the terminal 104 receives a login input by an operator in a login screen. Next, the terminal 104 receives an input where the operator selects a patient identifier in a patient selection screen. The medical information storing means 106 acquires workflow information corresponding to the acquired patient from the workflow information table 200 in FIG. 2. The operator selects a workflow No. in which a conference is held and the workflow input means 107 receives an input for selecting the workflow No. Next, the workflow output means 118 displays each workflow step information belonging to the workflow information of the selected workflow on a workflow execution screen 1500 (step S1200).

As shown in FIG. 15(A), a new conference step button 1501 is selected by the operator (step S1201).

As shown in FIG. 15(B), the operator selects a past workflow step from a workflow step selection area 1502 by the workflow input means 107 (step S1202). Here, as an example, a workflow step of the clinician A, whose workflow step No. is 5, is selected. The medical information table 300, the evidence data table 310, and the process history table 320 in FIG. 3 are searched for from the selected workflow step information No. and in the same process as that in steps S1003 to S1011 in FIG. 10, the evidence data of evidence No. 4 is selected and an image processing screen 1506 as shown in FIG. 15(C) is displayed (step S1203).

However, here, a reference mode and an editing mode can be set in each medical care support screen such as the image processing screen 1506. Normally, only the reference mode can be set in a past medical care support screen. However, when a conference is held, a medical care support screen can be set to the editing mode and editing can be performed.

While a conference is held, an editing process such as deleting or adding process history is performed on the image processing screen 1506 (step S1204). Here, as an example, data processing of filtering is added on the basis of a process procedure of image processing of the evidence No. 4 stored in the workflow step No. 5. The editing result is displayed in an evidence data display area 1504 (step S1205). For example, as a result of filtering data processing which is newly performed, it is assumed that a connection of 7 mm is further observed as the third tumor. The medical information output means 109 generates display data “#3: 7 mm” of the evidence data from the result of the data processing and displays the display data in the evidence data display area 704. Next, a decision in the conference is inputted in a decision text input/output area 1503 (step S1205). Here, the input information receiving means 108 receives an input of “Internal department/radiology department conference. Another connection of 7 mm is observed. Study TAE rather than RFA.” and the medical information output means 109 displays the input data in the decision text input/output area 1503.

Finally, a medical information registration button 1509 is selected (step S1207). The medical information storing means 106 calculates a new workflow step No. by adding, for example, 1 to the maximum workflow step No. in the workflow step information table 210 in the medical information database 105. Here, the new workflow step No. is 6 (step S1208). The medical information storing means 106 provides and registers the new workflow step No., the current date and time, and an executioner ID acquired from the login information into the workflow step information table 210. Further, the medical information storing means 106 registers medical information including the inputted decision text and the edited process history into the medical information table 300 in association with the new workflow step No. (step S1209). In this example, the evidence data of the process history edited as the evidence No. 5 is registered. Although there is one executioner ID field in the workflow step information table 210, an executioner input screen may be provided and a plurality of executioner IDs may be stored. In the workflow information table 200, a conference flag is provided to the corresponding workflow (workflow No. is 1) and a conference step flag is provided to the workflow step (workflow step No. is 6) in which the conference is held (step S1210).

Thereby, editing is performed while reproducing the process history and the process history is registered along with the decision text, so that it is possible to support a conference service by the medical staff. When the process history is reused in daily medical care at a later date, process histories when a conference is held are preferentially displayed and a process history is selected from the displayed process histories, so that it is possible to support a higher quality medical care.

### <Generation of Workflow Step>

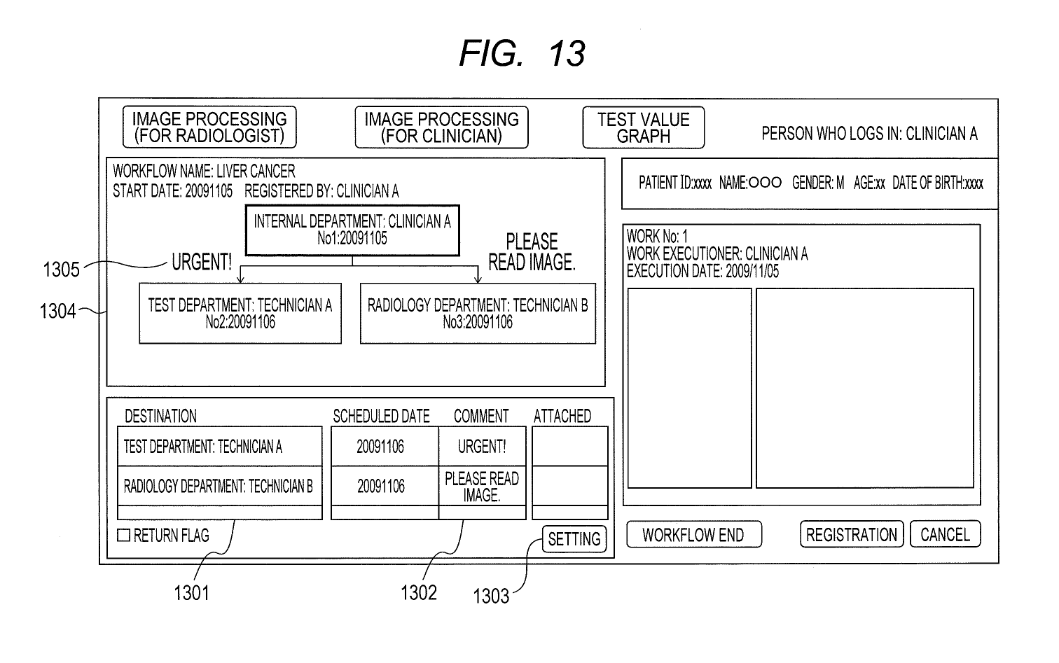

Next, generation of a workflow step will be described with reference to FIG. 13. FIG. 13 shows a next workflow step setting button 1303 that sets the next workflow step, a next workflow step request destination input area 1301, a message text input area 1302 in which a message text is inputted, a scheduled date input means, an attached file area, and a return flag input area. When the request destination, the message text, and the scheduled date are inputted and the next workflow step setting button 1303 is pressed, the inputted information is reflected in a workflow step display map 1304. The workflow step request input means 117 receives these inputs. The message text inputted into the message text input area 1302 is displayed in a message text display section 1305 in the workflow step display map 1304 by the medical information output means 109. Further, a workflow step No. is newly provided by the workflow step request input means 117 through the medical information storing means 106 and an execution scheduled department and an executioner ID are acquired from the request destination inputted into the request destination input area 1301. When a parent workflow step No. is acquired from the current workflow step No. which is the request source, a record is newly stored in the workflow step information table 210 in the medical information database 105. Further, it is possible to transmit an attached file and provide a return flag.

Thereby, it is possible to receive a request destination, a scheduled date, and a comment to generate workflow step information, so that the workflow step can be efficiently managed. Further, when the inputted request destination, scheduled date, and comment are displayed in the workflow step display map 1304, the workflow can be easily understood. The above request input may be realized by an ordering function included in the electronic medical record system 102 in cooperation with the electronic medical record system 102 shown in FIG. 1(A).

### <Example of Supporting Medical Care Using a Plurality of Workflows>

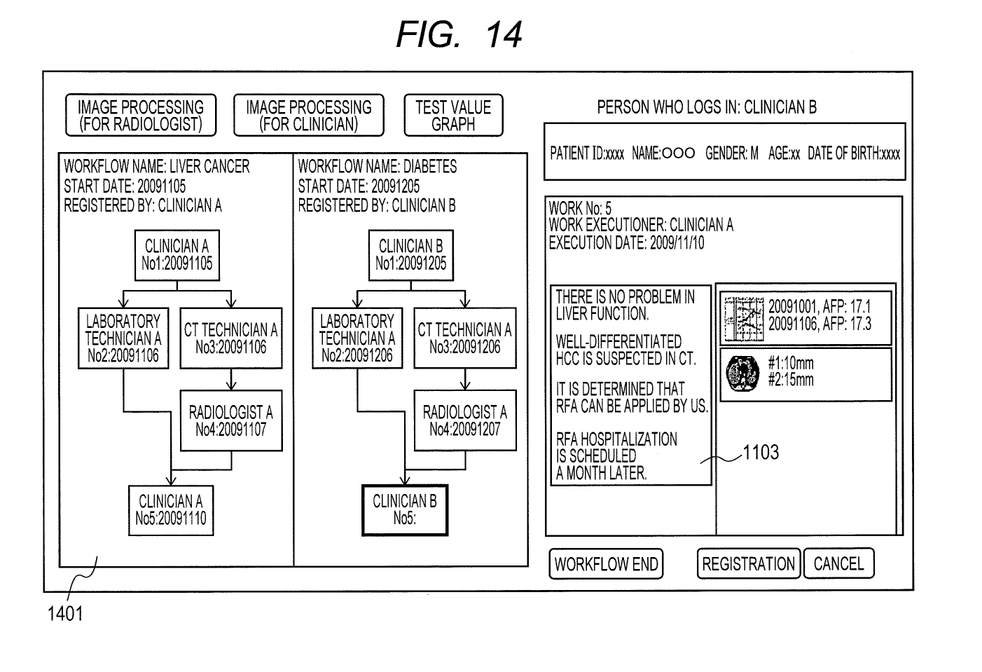

FIG. 14 shows a screen when medical care is performed by using a plurality of workflows. There is a case in which a plurality of diseases occur in one patient and medical care is performed by considering that these diseases affect each other and referring to workflows of these diseases. Here, an example will be described in which two different workflows of the same patient are used, specifically, a first workflow indicating a workflow of liver cancer and a second workflow indicating a workflow of diabetes are used. It is assumed that a workflow step of a clinician B, which belongs to the second workflow, is the ongoing workflow step. A case will be described below in which the clinician B refers to medical information performed in each workflow step in the workflow of liver cancer in the medical care of diabetes.

The workflow output means 118 acquires a plurality of pieces of workflow information from the workflow information table 200 in the medical information database 105 and outputs the plurality of pieces of workflow information in a workflow display map 1401 on the basis of a patient identifier inputted by the clinician B through the workflow input means 107. Further, the same operation as that shown in FIG. 9 is performed, so that the workflow input means 107 receives an input for selecting the workflow of liver cancer. The workflow output means 118 displays the selected workflow of liver cancer on the screen along with the workflow of diabetes which is the ongoing workflow. The workflow input means 107 receives an input for selecting a workflow step desired to be referred to from the displayed workflow of liver cancer and the medical information output means 109 displays medical information associated with the selected workflow step on the screen. Further, the input information receiving means 108 receives an input of a decision text in the ongoing workflow step belonging to the workflow of diabetes. The medical information storing means 106 registers the received decision text and the medical information in the workflow of liver cancer referred to into the medical information database 105 in association with the ongoing workflow step.

In this way, medical information associated with a workflow different from the ongoing workflow is referred to and the medical information referred to and an inputted decision text are accumulated in association with the ongoing workflow step, so that it is possible to support medical care which is performed while referring to medical information in a different workflow.

### INDUSTRIAL APPLICABILITY

The present invention relates to a medical care support system for handling test values and image data of patients and observations of medical staff, and also relates to a technique suitable for supporting decision of the medical staff in medical-related services.

### LIST OF REFERENCE SIGNS

101 medical care support system
102 electronic medical record system
103 PACS
104 terminal
105 medical information database
106 medical information storing means
107 workflow input means
108 input information receiving means
109 medical information output means
111 interface
112 memory
113 storage device
114 CPU
115 evidence data processing means
116 test information database
117 workflow step request input means
118 workflow output means
119 workflow end means
160 similar case search means
170 process analysis means
200 workflow information table
201 patient ID field
202 workflow No. field
203 workflow name field
204 workflow start date field
205 workflow end date field
206 primary doctor ID field
207 conference flag field
210 workflow step information table
211 patient ID field
212 workflow step No. field
213 workflow step execution scheduled department ID field
214 workflow step execution date and time field
215 workflow step executioner ID field
216 workflow step execution flag field
217 conference step flag field
218 workflow No. field
219 parent workflow step No. field
220 child workflow step No. field
300 medical information table
301 patient ID field
305 decision text field
306 reference workflow step No. field
310 evidence data table
311 evidence No. field
312 evidence type field
313 evidence display icon field
314 evidence display text field
320 process history table
321 process No. field
322 process content field
323 evidence No. field
324 process parameter field
330 input data table
331 evidence No. field
332 input data ID field
333 input data type field
400 test value table
401 test value ID field
402 patient ID field
403 test result date and time field
404 item code field
405 value field
410 test item master table
411 item code field
412 item name field
413 unit name field
420 measured value table
421 measured value ID field
422 patient ID field
423 measurement result date and time field
424 item code field
425 value field
430 measurement item master table
431 item code field
432 item name field
433 unit name field
434 registration date field
440 image table
441 image ID field
442 patient ID field
443 image acquisition date field
444 item code field
445 image field
700 workflow step execution screen
701 workflow step selection area
702 login information display area
703 decision text input/output area
704 evidence data display area
705 medical information registration button
706 medical care support button group
710 test value graph display screen
800 image processing screen
1101 workflow step selection area
1102 process history display area
1103 decision text input/output area
1104 evidence data display area
1105 process result display area
1108 workflow end button
1109 step reference history area
1110 image processing screen
1301 request destination input area
1302 message text input area
1303 next workflow step setting button
1304 workflow step display map
1305 message text display section
1401 workflow display map
1500 workflow execution screen
1501 new conference step button
1502 workflow step selection area
1503 decision text input/output area
1504 evidence data display area
1505 step reference history area
1506 image processing screen
1509 medical information registration button

1. A medical care support system comprising:
a medical information storing means that stores workflow information that identifies a workflow which is a series of flow of medical care of medical-related services, workflow step information including information that identifies a workflow step, which is a unit of a medical-related service included in the workflow, and information related to at least either one of a request source and a request destination of the medical-related service, and medical information which is information related to the medical-related service into a medical information database in association with each other;
a workflow input means that receives an input for selecting first workflow step information from the medical information database;
a medical information output means that extracts first medical information associated with the first workflow step information from the medical information database and displays the extracted first medical information on a screen; and
an input information receiving means that receives an input of information by a medical staff member,
wherein the medical information storing means stores information where an input is received by the input information receiving means and the first medical information into the medical information database as second medical information in association with second workflow step information that identifies a second workflow step which is an ongoing workflow step.

2. The medical care support system according to claim 1, further comprising:
a workflow step request input means that receives an input of information related to a request of a third workflow step executed after the second workflow step in the second workflow step,
wherein the medical information storing means stores information related to the request where the input is received and information that identifies the third workflow step into the medical information database as third workflow step information.

3. The medical care support system according to claim 2, wherein
the workflow step request input means receives an input of a message text related to the request in the second workflow step, and
the medical information output means displays the third workflow step information and the message text associated with the third workflow step information on the screen.

4. The medical care support system according to claim 1, wherein
the workflow information includes a patient identifier that identifies a patient, and
the medical care support system further includes a workflow output means that acquires workflow information different from workflow information of the ongoing workflow from the medical information database from the patient identifier included in workflow information of workflow including the ongoing workflow step and displays the workflow information.

5. The medical care support system according to claim 4, wherein
the workflow input means receives an input for selecting workflow step information from workflow information different from the workflow information of the ongoing workflow displayed on the screen, and
the medical information output means extracts medical information associated with the selected workflow step information from the medical information database and displays the extracted medical information on the screen.

6. The medical care support system according to claim 1, wherein
the medical information includes evidence data which is objective biological information acquired from the patient.

7. The medical care support system according to claim 6, further comprising:
an evidence data processing means that processes the evidence data,
wherein the medical information includes a process history of processing the evidence data by the evidence data processing means, and
the medical information output means displays the process history on the screen.

8. The medical care support system according to claim 7, wherein
the evidence data processing means receives an input for editing the displayed process history, and
the medical information storing means registers the edited process history into the medical information database in association with workflow step information associated with the evidence data.

9. The medical care support system according to claim 1, further comprising:
a workflow end means that provides workflow end information to the workflow information and stores the workflow information into the medical information database.

10. The medical care support system according to claim 1, further comprising:
a similar case search means that searches for medical information associated with a case similar to a specified case from the medical information database and outputs the searched medical information and workflow information, to which workflow step information associated with the searched medical information belongs, to the screen.

11. The medical care support system according to claim 1, wherein
the medical information includes at least one of the information, a test value, image data, a test value processing history of the test value, and an image processing history of the image data.

12. A method of supporting medical care which supports medical care by using a medical information database for storing workflow information that identifies a workflow which is a series of flow of medical care of medical-related services, workflow step information including information that identifies a workflow step, which is a unit of a medical-related service included in the workflow, and information related to at least either one of a request source and a request destination of the medical-related service, and medical information which is information related to the medical-related service in association with each other, the method of supporting medical care comprising:
receiving an input for selecting first workflow step information from the medical information database by a workflow input means;
extracting first medical information associated with the first workflow step information, where the input is received, from the medical information database and displaying the extracted first medical information on a screen;
receiving an input of information from a medical staff member by an input information receiving means; and
storing the displayed first medical information and the information where the input is received into the medical information database as second medical information in association with second workflow step information that identifies a second workflow step which is an ongoing workflow step.

13. The method of supporting medical care according to claim 12, further comprising:
receiving an input of information related to a request of a third workflow step, which is executed after the second workflow step, by a workflow step request input means; and
storing the inputted information related to the request and information that identifies the third workflow step into the medical information database as third workflow step information.

14. The method of supporting medical care according to claim 12, wherein
the medical information includes evidence data which is objective biological information acquired from the patient, and
the method of supporting medical care further includes
processing the evidence data by an evidence data processing means, and
displaying the processed process history on the screen.
